(19) United States
(12) Patent Application Publication
(10) Pub. No.: US 2015/0268382 A1
(43) Pub. Date: Sep. 24, 2015

(54) COMPOSITE OPTICAL DEVICE AND OPTICAL MATERIAL FOR COMPOSITE OPTICAL DEVICE

(71) Applicant: Panasonic Intellectual Property Management Co., Ltd., Osaka (JP)

(72) Inventor: Nobuyuki KOBAYASHI, Hyogo (JP)

(21) Appl. No.: 14/641,547

(22) Filed: Mar. 9, 2015

(30) Foreign Application Priority Data
Mar. 24, 2014 (JP) 2014-060154
Dec. 12, 2014 (JP) 2014-252226

(51) Int. Cl. G02B 1/04; G02B 27/00; G02B 9/02

(52) U.S. Cl. CPC G02B 1/041; G02B 9/02; G02B 27/0025

(57) ABSTRACT

Provided are a composite optical device including a glass lens; and a resin lens stacked on the glass lens, wherein the resin lens is formed of an optical material; and the optical material comprises an optical resin composition which contains at least a (meth)acrylate-based polymerizable compound; and an aliphatic polyimide precursor obtained from a carboxylic acid anhydride having in a molecular structure, a structure represented by general formula (α): -A¹-CO—O—CO-A²- wherein A¹ and A² are, each independently, a linear, branched or cyclic aliphatic group; and A¹ and A² may form the same cyclic aliphatic group, the aliphatic polyimide precursor being dispersed in a resin material including the (meth)acrylate-based polymerizable compound, and an optical material for a composite optical device.

### BACKGROUND

1. Field

The present disclosure relates to a composite optical device and an optical material for a composite optical device.

2. Description of the Related Art

Optical devices require various aberration corrections, and particularly in recent years, development on optical devices formed of optical materials having abnormal dispersibility has been conducted with the intention of reducing chromatic aberration.

Unexamined Japanese Patent Publication No. 2010-037470 discloses an optical device obtained using a material composition which contains a (meth)acryloyloxy group-containing compound having a fluorene ring; a compound having at least one (meth)acryloyl group or a vinyl group per molecule and having no fluorene ring; and a polymerization initiator.

### SUMMARY

A composite optical device in the present disclosure includes

a glass lens; and a resin lens stacked on the glass lens, wherein

the resin lens is formed of an optical material; and

the optical material comprises an optical resin composition which contains

at least

a (meth)acrylate-based polymerizable compound; and

an aliphatic polyimide precursor obtained from a carboxylic acid anhydride having in a molecular structure, a structure represented by general formula (α): -A¹-CO—O—CO-A²- wherein A¹ and A² are, each independently, a linear, branched or cyclic aliphatic group; and A¹ and A² may form the same cyclic aliphatic group,

the aliphatic polyimide precursor being dispersed in a resin material including the (meth)acrylate-based polymerizable compound.

### BRIEF DESCRIPTION OF DRAWINGS

FIG. 1 is a schematic block diagram of a hybrid lens as one example of a composite optical device according to an exemplary embodiment;

FIG. 2 is a schematic view of an optical material to be used in the composite optical device;

FIG. 3A is a schematic explanatory view showing a first process for producing the hybrid lens;

FIG. 3B is a schematic explanatory view showing a second process for producing the hybrid lens; and

FIG. 3C is a schematic explanatory view showing a third process for producing the hybrid lens.

### DETAILED DESCRIPTION

An exemplary embodiment will be described below with reference to the drawings as appropriate. It is to be noted that unnecessarily detailed descriptions may be omitted. For example, detailed descriptions of well known matters and duplicate descriptions of substantially the same configurations may be omitted. This is intended to prevent the following descriptions from becoming lengthy unnecessarily, so that a person skilled in the art can easily understand the present disclosure.

The inventor provides the attached drawings and the following descriptions for a person skilled in the art to sufficiently understand the present disclosure, and does not intend to thereby limit the subject matters described in claims.

### [1. Hybrid Lens]

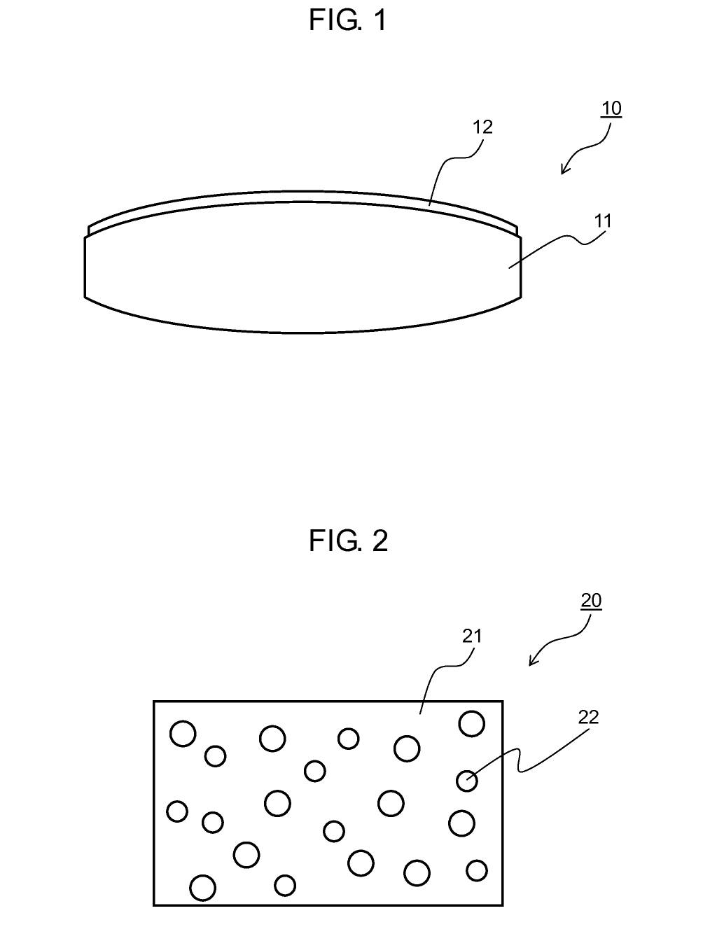

FIG. 1 is a schematic block diagram of a hybrid lens according to the exemplary embodiment. Hybrid lens 10 includes first lens 11 and second lens 12. Hybrid lens 10 is one example of a composite optical device.

First lens 11 is one example of a glass lens, and is formed of a glass material. First lens 11 is a biconvex lens.

Second lens 12 is one example of a resin lens, and is formed of optical material 20 shown in FIG. 2. Second lens 12 is stacked on one of optical surfaces of first lens 11.

### [2. Optical Material]

FIG. 2 is a schematic view of the optical material. Optical material 20 is a material configured to form the resin lens that forms hybrid lens 10, and FIG. 2 is a view for explaining in detail second lens 12 shown in FIG. 1.

Optical material 20 includes an optical resin composition containing at least a (meth)acrylate-based polymerizable compound and an aliphatic polyimide precursor, and aliphatic polyimide precursor 22 is dispersed in resin material 21 as a matrix material, which includes the (meth)acrylate-based polymerizable compound.

### [3. Resin Material]

Resin material 21 includes a (meth)acrylate-based polymerizable compound, and as the (meth)acrylate-based polymerizable compound, one that is generally used in optical applications may be used. Examples of the (meth)acrylate-based polymerizable compound include monofunctional (meth)acrylates such as methyl(meth)acrylate, ethyl(meth)acrylate, cyclohexyl(meth)acrylate, dicyclopentyl(meth)acrylate, isobornyl(meth)acrylate, bornyl(meth)acrylate, phenyl(meth)acrylate, halogen-substituted phenyl(meth)acrylate, benzyl(meth)acrylate, α-naphthyl(meth)acrylate, β-naphthyl(meth)acrylate and dicyclopentyloxyethyl acrylate; and polyfunctional (meth)acrylates such as ethylene glycol dimethacrylate, triethylene glycol di(meth)acrylate, polyethylene glycol di(meth)acrylate, neopentyl glycol di(meth)acrylate, 1,4-butanediol di(meth)acrylate, 1,6-hexanediol di(meth)acrylate, hydrogenated dicyclopentadienyl di(meth)acrylate, ethylene oxide-modified bisphenol A di(meth)acrylate, trimethylolpropane tri(meth)acrylate, pentaerythritol tetra (meth)acrylate, tetramethylolmethane tetra(meth)acrylate, pentaerythritol hexa(meth)acrylate, hexanediol diglycidyl ether di(meth)acrylate and diethylene glycol diglycidyl ether di(meth)acrylate. They may be used alone or in combination of two or more thereof.

Besides the above-mentioned monofunctional (meth)acrylates and polyfunctional (meth)acrylates, for example, at least one of monofunctional (meth)acrylate-based polymerizable compounds represented by the following chemical formula (2) and polyfunctional (meth)acrylate-based polymerizable compounds represented by the following chemical formulae (1) and (3) to (59) may be used. In the present disclosure, the “(meth)acryl” means “acryl” or “methacryl”.

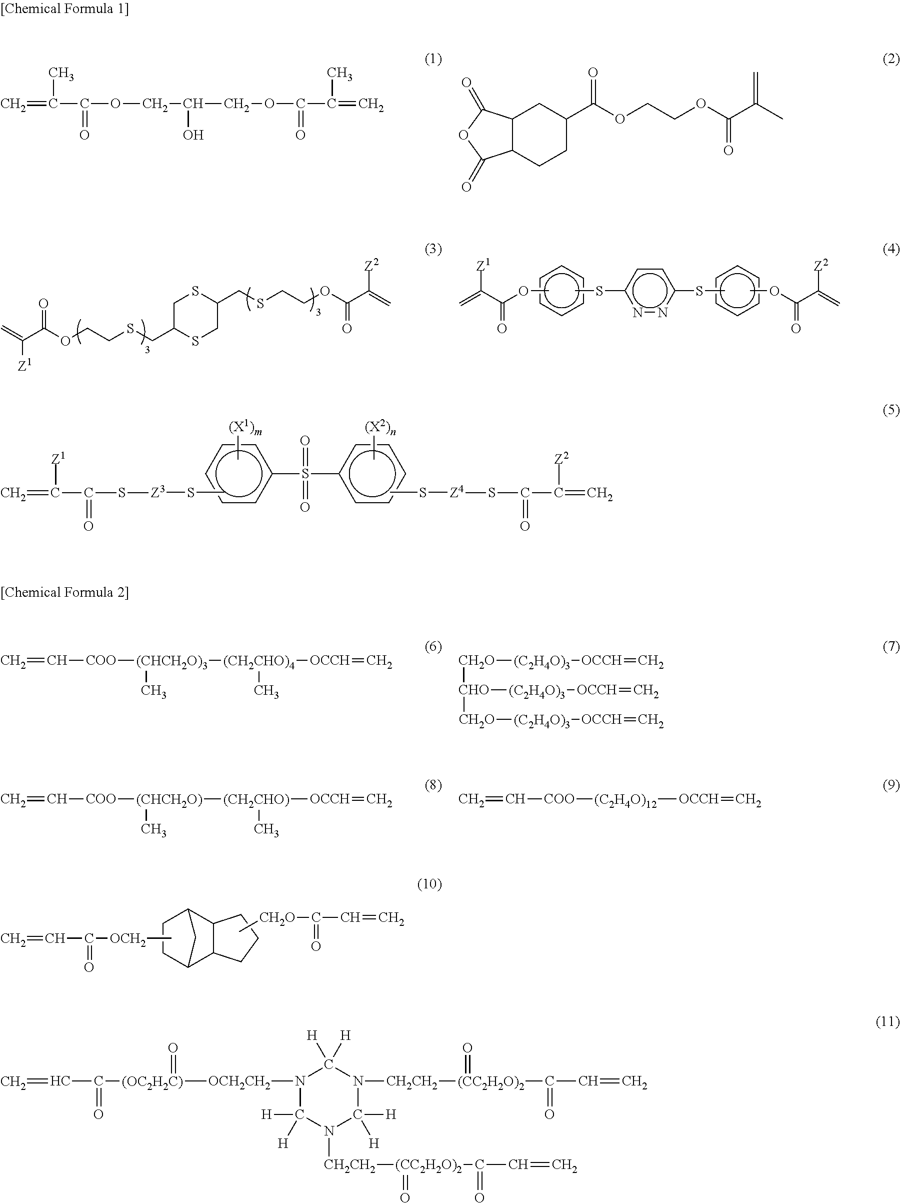

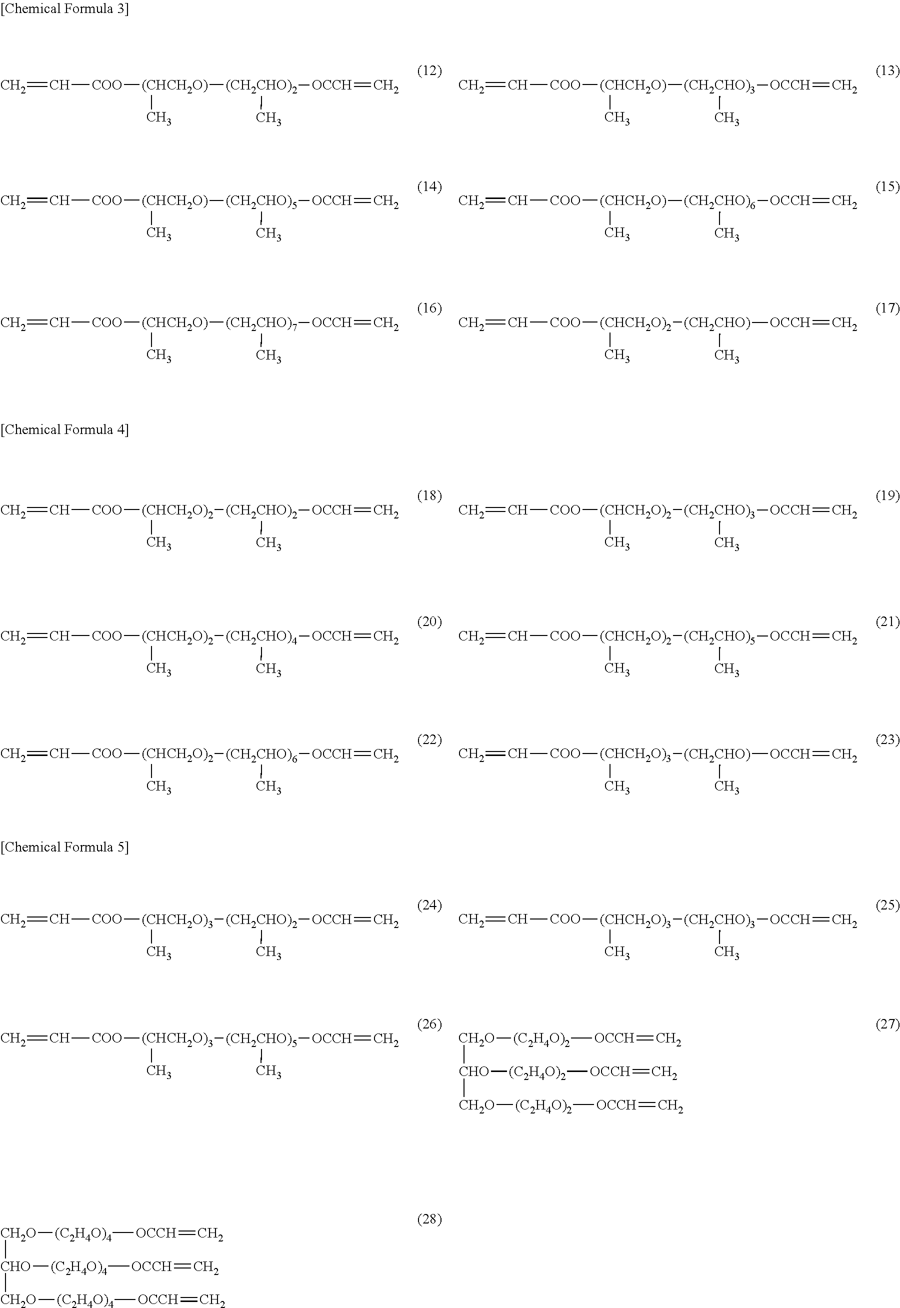

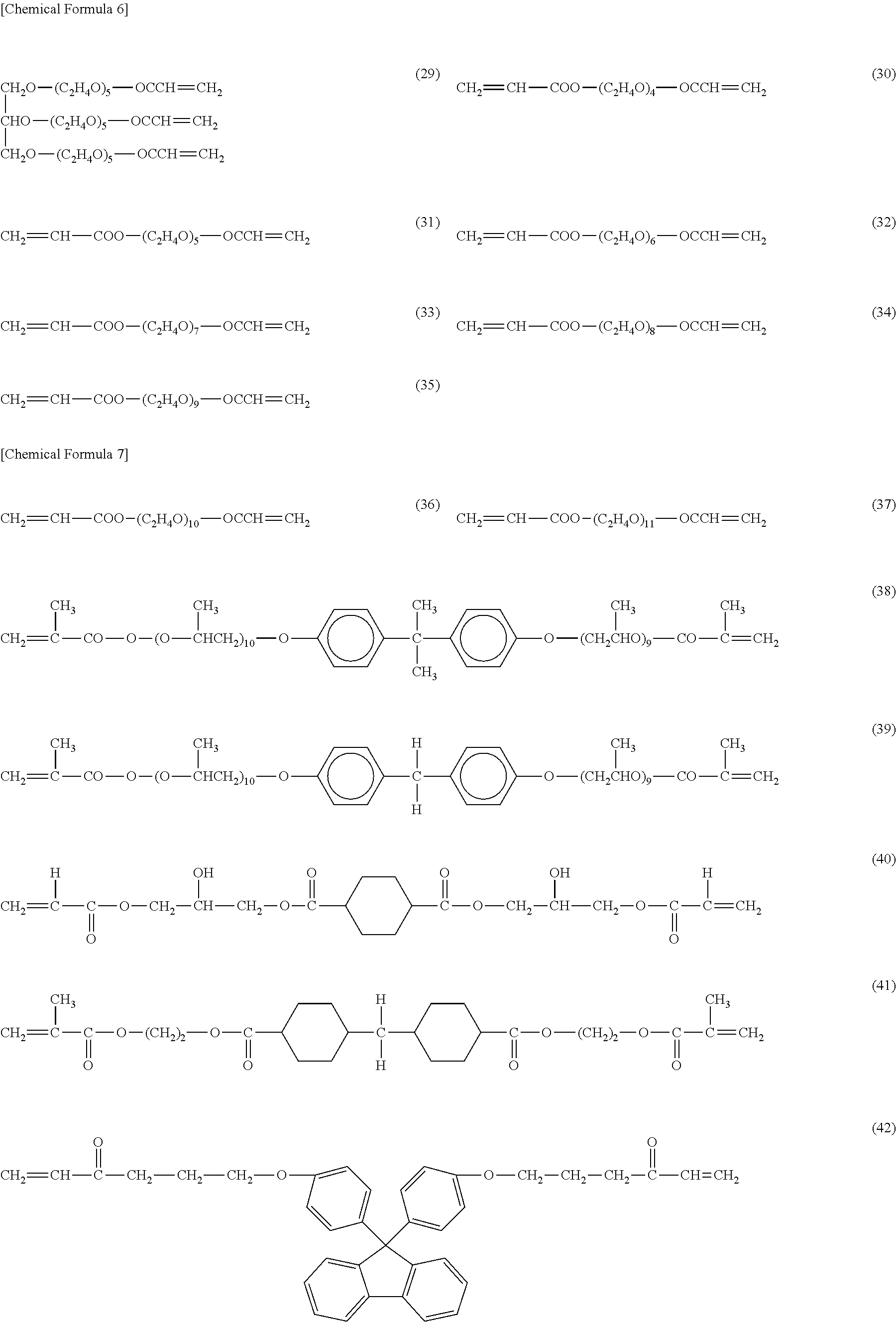

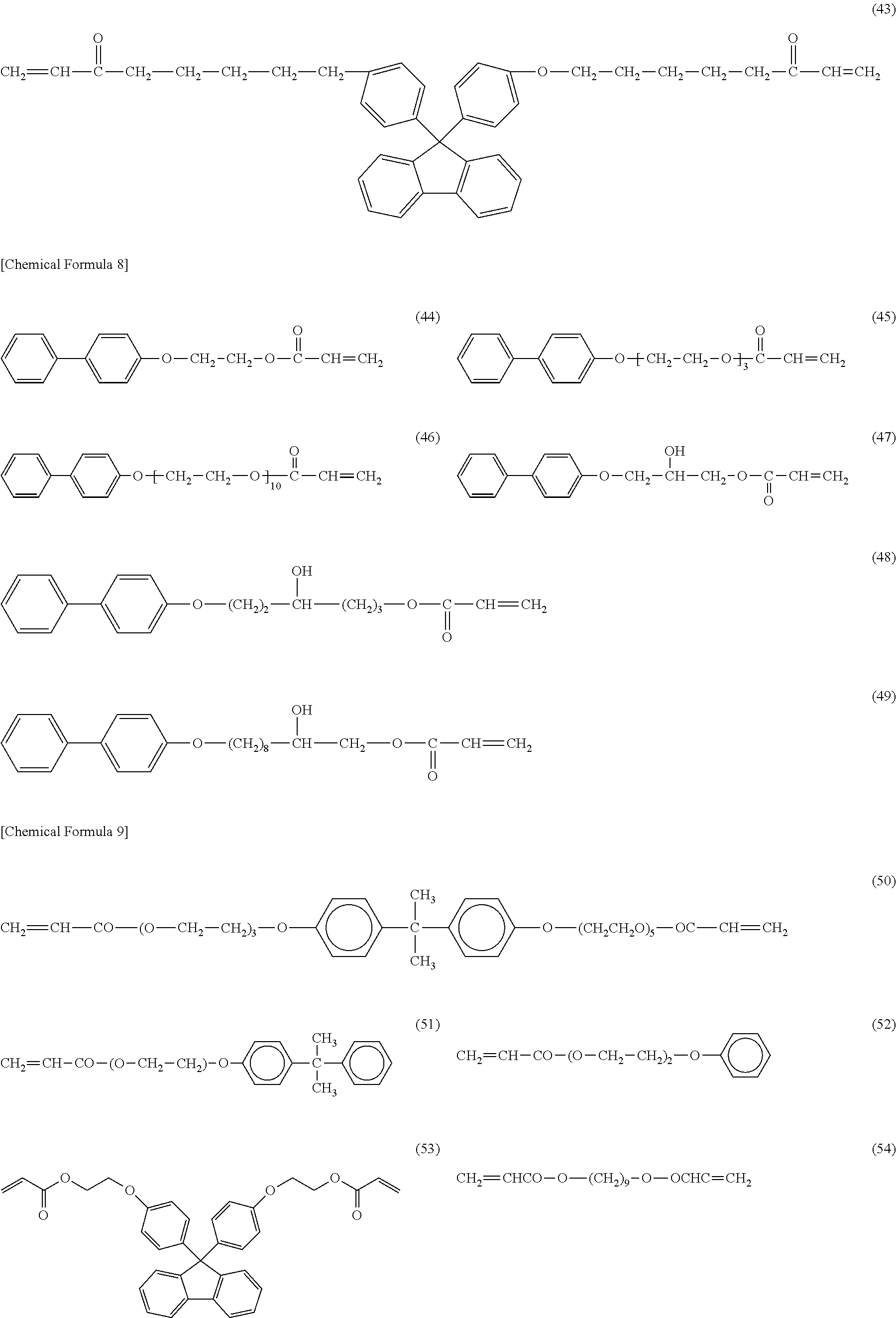

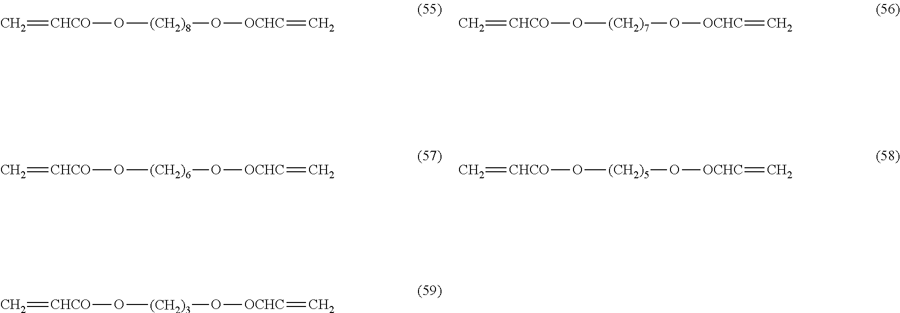

In the chemical formulae (3), (4) and (5), Z¹ and Z² each independently represent a hydrogen atom or a methyl group. In the chemical formula (5), Z³ and Z⁴ each independently represent a linear, branched or cyclic divalent aliphatic group etc. which may have a substituent, X⁴ and X² each independently represent a halogen atom such as a fluorine atom, a chlorine atom or a bromine atom, and m and n each independently represent an integer of 0 to 4.

It is preferred that resin material 21 includes at least one of (meth)acrylate-based polymerizable compounds represented by the chemical formulae (1) and (2) among the above mentioned compounds because dispersibility of later-described aliphatic polyimide precursor 22 is made more satisfactory.

It is preferred that resin material 21 includes at least one of (meth)acrylate-based polymerizable compounds having sulfur atoms in a molecular structure, such as those represented by the chemical formulae (3) to (5) because a refractive index of optical material 20 including the resulting optical resin composition is further increased.

### [4. Aliphatic Polyimide Precursor]

Aliphatic polyimide precursor 22 that is uniformly dispersed in resin material 21 including a (meth)acrylate-based polymerizable compound can significantly reduce abnormal dispersibility while further improving transparency of resin material 21.

For example, an attempt has been previously made to dissolve and disperse a polyimide in a resin, but heating at a high temperature of, for example, 270 to 300° C. is required because the polyimide has low solubility in the resin, and moreover, the polyimide is blown and therefore difficult to apply to an optical material.

On the other hand, when aliphatic polyimide precursor 22 is dispersed in resin material 21 including a (meth)acrylate-based polymerizable compound, not only high transparency and large negative abnormal dispersibility but also high heat resistance and a high refractive index are imparted to optical material 20.

Aliphatic polyimide precursor 22 has satisfactory solubility in resin material 21 including a (meth)acrylate-based polymerizable compound, and therefore does not require heating at a high temperature of 270 to 300° C. as is required when a polyimide is used. In the present disclosure, aliphatic polyimide precursor 22 is dissolved at a temperature of preferably 200° C. or lower, further preferably 170° C. or lower, and dispersed in resin material 21.

Aliphatic polyimide precursor 22 in the present disclosure is obtained from a carboxylic acid anhydride having in a molecular structure a structure represented by general formula (α): -A¹-CO—O—CO-A²- wherein A¹ and A² are, each independently, a linear, branched or cyclic aliphatic group; and A² and A¹ may form the same cyclic aliphatic group. Aliphatic polyimide precursor 22 can be obtained by subjecting the carboxylic acid anhydride and a diamine to a polymerization reaction.

Examples of the linear, branched or cyclic aliphatic group represented by A¹ and A² in the structure represented by the general formula (α) include linear, branched and cyclic, alkylene groups, alkenylene groups and alkynylene groups which may have a substituent containing an oxygen atom, a nitrogen atom, a sulfur atom and the like. A¹ and A² forming the same cyclic aliphatic group means that A¹ and A² are bonded to each other directly, or A¹ and A² are bonded to each other via an alkylene group, an alkenylene group, an alkynylene group in the linear or branched form or the like to form a cycloalkylene group, a cycloalkenylene group, a cycloalkynylene group or the like which may have a substituent containing an oxygen atom, a nitrogen atom, a sulfur atom and the like.

Examples of the carboxylic acid anhydride having a structure represented by general formula (α) include tetracarboxylic dianhydrides represented by general formula (β):

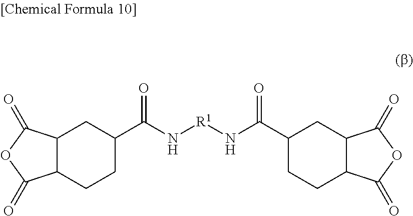

wherein R¹ is a divalent group represented by formula (β-1):

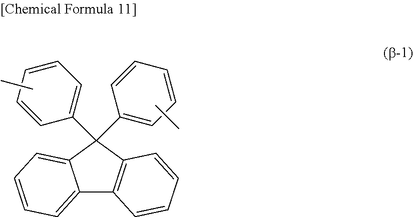

or formula (β-2):

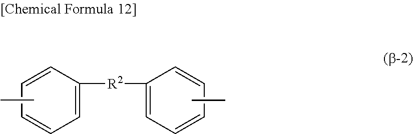

or formula (β-3):

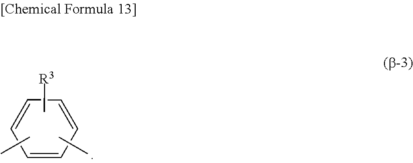

Examples of R² in the divalent group represented by formula (β-2) include —SO₂—, —CH₂—, —O—, —C(CH₃)₂— and —NH—. Examples of R³ in the divalent group represented by formula (β-3) include —H and —COOH.

It is preferred to use, among the above-mentioned compounds, tetracarboxylic acid dianhydrides represented by the following chemical formulae (60) and (61) because aliphatic polyimide precursor 22 having a large effect of improving transparency, negative abnormal dispersibility, heat resistance and a refractive index is obtained.

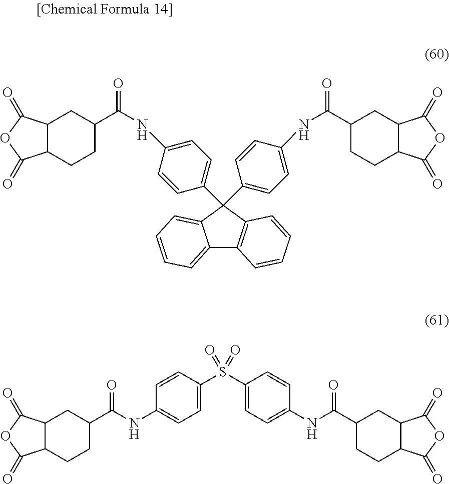 [SMILES: O=C(Nc1ccc(C2(c3ccc(NC(=O)C4CCC5C(=O)OC(=O)C5C4)cc3)c3ccccc3-c3ccccc32)cc1)C1CCC2C(=O)OC(=O)C2C1 ; O=C(Nc1ccc(S(=O)(=O)c2ccc(NC(=O)C3CCC4C(=O)OC(=O)C4C3)cc2)cc1)C1CCC2C(=O)OC(=O)C2C1]

The diamine that is subjected to a polymerization reaction with the carboxylic acid anhydride having in a molecular structure a structure represented by general formula (α) is not particularly limited, and a usual aliphatic diamine or aromatic diamine may be used.

Examples of the aliphatic diamine include linear diamines such as 1,2-diaminoethane, 1,3-diaminopropane, 1,4-diaminobutane, 1,5-diaminopentane, 1,6-hexanediamine, 1,7-heptanediamine, 1,8-octanediamine, 1,9-nonanediamine, 1,10-decanediamine, 1,11-undecanediamine and 1,12-dodecanediamine, branched diamines such as 1,2-diaminopropane, 1,2-diamino-2-methylpropane, 1,3-diamino-2-methylpropane, 1,3-diamino-2,2-dimethylpropane, 1,3-diaminopentane and 1,5-diamino-2-methylpentane; and cyclic diamines such as 5-amino-1,3,3-trimethylcyclohexanemethylamine (isophorone diamine), 1,4-diaminocyclohexane, 1,3-diaminocyclohexane, 1,4-cyclohexane-bis(methylamine), 1,3-cyclohexane-bis(methylamine), 4,4′-diaminodicyclohexylmethane and bis(4-amino-3-methylcyclohexyl)methane.

Examples of the aromatic diamine include p-phenylenediamine, 2,3,5,6-tetramethyl-p-phenylenediamine, 2,5-dimethyl-p-phenylenediamine, m-phenylenediamine, 2,4-dimethyl-m-phenylenediamine, 2,5-diaminotoluene, 2,6-diaminotoluene, 2,5-diaminophenol, 2,4-diaminophenol, 3,5-diaminophenol, 3,5-diaminobenzyl alcohol, 2,4-diaminobenzyl alcohol, 4,6-diaminoresorcinol, 4,4′-diaminobiphenyl, 3,3′-dimethyl-4,4′-diaminobiphenyl, 3,3′-dimethoxy-4,4′-diaminobiphenyl, 3,3′-dihydroxy-4,4′-diaminobiphenyl, 3,3′-dicarboxy-4,4′-diaminobiphenyl, 3,3′-difluoro-4,4′-biphenyl, 3,3′-trifluoromethyl-4,4′-diaminobiphenyl, 3,4′-diaminobiphenyl, 3,3-diaminobiphenyl, 2,2′-diaminobiphenyl, 2,3′-diaminobiphenyl, 4,4′-diaminodiphenylmethane, 3,3′-diaminodiphenylmethane, 3,4′-diaminodiphenylmethane, 2,2′-diaminodiphenylmethane, 2,3′-diaminodiphenylmethane, 4,4′-diaminodiphenyl ether, 3,3′-diaminodiphenyl ether, 3,4′-diaminodiphenyl ether, 2,2′-diaminodiphenyl ether and 2,3′-diaminodiphenyl ether.

The method for producing aliphatic polyimide precursor 22 is not particularly limited, and it is only necessary to subject an appropriately selected carboxylic acid anhydride and diamine to a polymerization reaction in an organic solvent. The organic solvent to be used is not particularly limited, and examples thereof include N,N-dimethylformamide, N,N-dimethylacetamide, N-methyl-2-pyrrolidone, methyl ethyl ketone, ethylene glycol, propylene glycol, diethyl ether, cyclohexanone, ethyl acetate and n-butyl acetate. They may be used alone, or may be used in mixture of two or more thereof.

Examples of the method for reacting a carboxylic acid anhydride with a diamine in an organic solvent include a method in which a solution with a diamine dispersed or dissolved in an organic solvent is stirred while a carboxylic acid anhydride is added to the solution directly or in the form of a dispersion or a solution in an organic solvent, a method in which conversely a diamine is added to a solution with a carboxylic acid anhydride dispersed or dissolved in an organic solvent, and a method in which a carboxylic acid anhydride and a diamine are alternately added. Any of these methods may be employed. When the reaction is carried out using two or more diamines and/or carboxylic acid anhydrides, the two or more diamines and/or carboxylic acid anhydrides may be mixed beforehand and reacted, or individually reacted in succession, or individually reacted low-molecular-weight substances may be mixed and reacted. A polymerization temperature and a polymerization time may be appropriately adjusted according to types of the carboxylic acid anhydride and diamine to be used.

For collecting intended aliphatic polyimide precursor 22 from a polymerization solution of the carboxylic acid anhydride and the diamine, the polymerization reaction solution may be placed in a solvent and precipitated. Examples of the solvent to be used for precipitation include methanol, acetone, hexane, butyl cellosolve, heptane, methyl ethyl ketone, methyl isobutyl ketone, ethanol, toluene, benzene and water. The reaction product precipitated in the solvent may be filtered and collected, and then dried by performing heating at normal temperature or an appropriate temperature under normal pressure or reduced pressure.

A molecular weight of aliphatic polyimide precursor 22 is not particularly limited as long as not only high transparency and significant negative abnormal dispersibility but also high heat resistance and a high refractive index are imparted to optical material 20, but the molecular weight of aliphatic polyimide precursor 22 is preferably about 500 to 2000 in terms of a weight average molecular weight.

An amount of aliphatic polyimide precursor 22 is not particularly limited, and may be appropriately adjusted while a ratio to resin material 21 in which aliphatic polyimide precursor 22 is dispersed is taken into consideration according to optical properties such as negative abnormal dispersibility and a refractive index of an intended optical material, but the amount of aliphatic polyimide precursor 22 is preferably 50% by weight or less, further preferably 30% by weight or less based on a total amount of the optical resin composition, and preferably 1% by weight or more, further preferably 5% by weight or more based on the total amount of the optical resin composition.

### [5. Polymerization Initiator]

Optical material 20 including the optical resin composition is one in which aliphatic polyimide precursor 22 is dissolved at a temperature of preferably 200° C. or lower, and dispersed in resin material 21, and since as described later, optical material 20 is cured, and second lens 12 is stacked on first lens 11 to form hybrid lens 10 as shown in FIG. 1, it is preferred that the optical resin composition contains a polymerization initiator.

A type of the polymerization initiator is not particularly limited, and may be appropriately selected according to a type of resin material 21 to be used, but a known photoradical polymerization initiator such as, for example, an acetophenone-based, benzoin-based, benzophenone-based, thioxane-based or acylphosphine oxide-based photoradical polymerization initiator may be used. It is preferred to use, among the above-mentioned compounds, a hydroxyketone compound having a weight average molecular weight of 1000 to 2000 because larger negative abnormal dispersibility and a high refractive index can be imparted to the optical material. An amount of the polymerization initiator is not particularly limited, and is, for example, preferably 1 to 5% by weight based on the total amount of the optical resin composition.

### [6. Abnormal Dispersibility]

Abnormal dispersibility ΔPgF is a deviation between a point on a standard line of normal dispersion glass, which corresponds to Abbe number νd on a d-line (wavelength: 588 nm) of each material, and partial dispersion ratio PgF of the material. Partial dispersion ratio PgF is defined by the following formula (b):

PgF=(ng−nF)/(nF−nC) (b)

wherein

ng is a refractive index at a g-line (wavelength: 436 nm) of the material;

nF is a refractive index at a F-line (wavelength: 486 nm) of the material; and

nC is a refractive index at a C-line (wavelength: 656 nm) of the material.

Preferably, the resin lens in this exemplary embodiment, i.e. second lens 12, satisfies the following requirement (a):

ΔPgF<−0.02 (a)

wherein

ΔPgF is abnormal dispersibility.

A prism coupler (manufactured by Metricon Corporation, MODL 2010) may be used for measuring the refractive index, the Abbe number and ΔPgF.

### [7. Production Method]

A method for producing hybrid lens 10 will be described with reference of the drawings. Here, resin material 21 that forms optical material 20 is an ultraviolet-curable acryl-based resin.

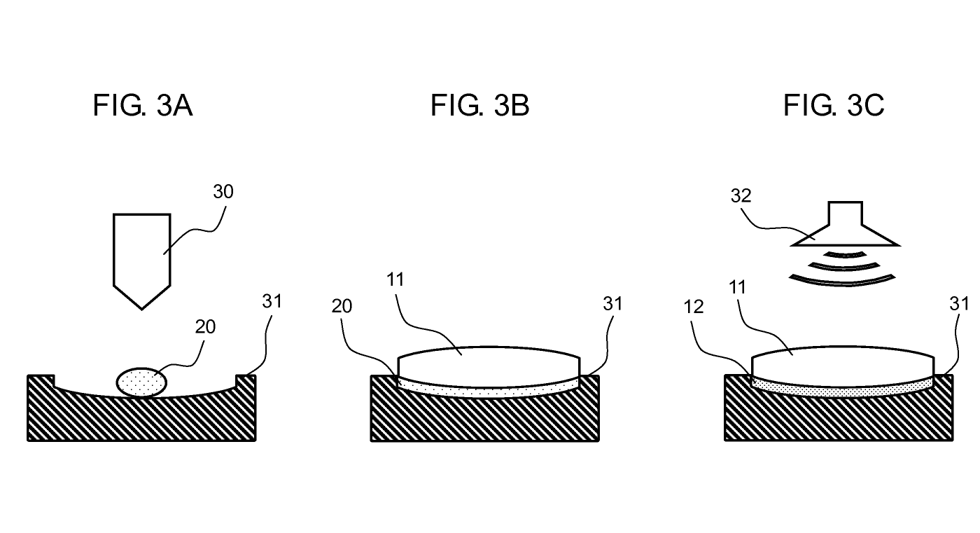

FIG. 3C is a schematic explanatory view showing a process for producing the hybrid lens according to the exemplary embodiment. First, first lens 11 is molded. The method for producing first lens 11 as one example of a glass lens is not particularly limited, and first lens 11 is molded using a known production method such as injection molding or press molding.

As shown in FIG. 3A, optical material 20 is discharged to a molding surface of mold 31 using dispenser 30.

Next, as shown in FIG. 3B, first lens 11 is placed on the mold from above optical material 20, and pressed to spread out optical material 20 to a predetermined thickness. Mold 31 is then placed on a rotary table (not illustrated), and rotated.

As shown in FIG. 3C, ultraviolet rays are applied from above first lens 11 using light source 32, so that optical material 20 is cured to obtain hybrid lens 10 as a composite optical device 11 in which second lens 12 as a resin lens is stacked on first lens 11 as a glass lens.

The exemplary embodiment has been described above as an example of the technique disclosed in the present application. However, the technique in the present disclosure is not limited to the above-mentioned exemplary embodiment, and is also applicable to exemplary embodiments where modification, replacement, addition, omission and so on are appropriately made.

### EXAMPLES

Examples related to this exemplary embodiment, and comparative examples are shown below. The present disclosure is not limited to these examples.

Results of the examples and comparative examples are shown in Table 1 below. Optical properties of resin lens were measured using a prism coupler (manufactured by Metricon Corporation, MODL 2010). In Table 1, nd denotes a refractive index at a d-line, and a transmittance (% T) is a transmittance of light having a wavelength of 400 nm.

### Example 1

To 0.9207 g of a compound represented by the chemical formula (1) (hereinafter referred to as resin material A), were added 0.0466 g of an aliphatic polyimide precursor (weight average molecular weight: 936; hereinafter referred to as precursor A) obtained by subjecting to a polymerization reaction of a tetracarboxylic acid dianhydride represented by the chemical formula (60) and 4,4′-diaminodiphenyl ether, and 0.029 g of Irgacure 184 (1-hydroxycyclohexyl phenyl ketone manufactured by BASF; weight average molecular weight: 204; hereinafter referred to as photopolymerization initiator a) as a polymerization initiator, and the mixture was mixed at 150° C. to obtain an optical material including an optical resin composition with precursor A dispersed in resin material A.

Thereafter, the optical material was cured by applying UV light (80 mW/cm²·90 sec) using an UV irradiation device (SP-9 manufactured by USHIO INC.), so that a resin lens sample (thickness: 50 μm) was prepared. In each of Examples 2 to 5 and Comparative Examples 1 to 3, a sample was prepared in accordance with the same procedure as above.

Next, a hybrid lens was prepared using the obtained optical material as in the schematic explanatory view shown in FIG. 3.

The optical material was discharged to a molding surface of a mold using a dispenser, a biconvex glass lens (center thickness: about 5 mm) was then placed on the mold from above the optical material, and pressed to spread out the optical material to a predetermined thickness. The mold was then placed on a rotary table, and rotated. The optical material was then cured by applying UV light (80 mW/cm²·90 sec) from above the glass lens, so that a hybrid lens with a meniscus-shaped resin lens (center thickness: about 0.1 mm) stacked on the biconvex glass lens was obtained. In each of Examples 2 to 5 and Comparative Examples 1 to 3, a hybrid lens was prepared in accordance with the same procedure as above.

As shown in Table 1, the sample of Example 1 shows large negative abnormal dispersibility satisfying the requirement (a), has high transparency with a transmittance of more than 89%, and has high heat resistance and a high refractive index of more than 1.51. Therefore, the hybrid lens of Example 1 has high transparency, large negative abnormal dispersibility, high heat resistance and a high refractive index.

### Example 2

A sample and a hybrid lens of Example 2 were prepared in the same manner as in Example 1 except that the amount of resin material A was changed to 1.1419 g, the amount of precursor A was changed to 0.2854 g, and the amount of photopolymerization initiator a was changed to 0.044 g in Example 1.

As shown in Table 1, the sample of Example 2 shows large negative abnormal dispersibility satisfying the requirement (a), has high transparency with a transmittance of more than 86%, and has high heat resistance and a high refractive index of more than 1.52. Therefore, the hybrid lens of Example 2 has high transparency, large negative abnormal dispersibility, high heat resistance and a high refractive index.

### Example 3

A sample and a hybrid lens of Example 3 were prepared in the same manner as in Example 1 except that 0.9207 g of resin material A was changed to 1.1100 g of a compound represented by the chemical formula (2) (hereinafter referred to as resin material B), 0.0466 g of precursor A was changed to 0.0230 g of an aliphatic polyimide precursor (weight average molecular weight: 774; hereinafter referred to as precursor B) obtained by subjecting to a polymerization reaction of a tetracarboxylic acid dianhydride represented by the chemical formula (61) and 4,4′-diaminodiphenyl ether, the amount of photopolymerization initiator a was changed to 0.035 g, and the mixing temperature was changed to 80° C. in Example 1.

As shown in Table 1, the sample of Example 3 shows large negative abnormal dispersibility satisfying the requirement (a), has high transparency with a transmittance of more than 89%, and has high heat resistance and a high refractive index of more than 1.51. Therefore, the hybrid lens of Example 3 has high transparency, large negative abnormal dispersibility, high heat resistance and a high refractive index.

### Example 4

A sample and a hybrid lens of Example 4 were prepared in the same manner as in Example 3 except that the amount of resin material B was changed to 0.9208 g, the amount of precursor B was changed to 0.0462 g, and the amount of photopolymerization initiator a was changed to 0.020 g in Example 3.

As shown in Table 1, the sample of Example 4 shows large negative abnormal dispersibility satisfying the requirement (a), has high transparency with a transmittance of more than 87%, and has high heat resistance and a high refractive index of more than 1.52. Therefore, the hybrid lens of Example 4 has high transparency, large negative abnormal dispersibility, high heat resistance and a high refractive index.

### Example 5

A sample and a hybrid lens of Example 5 were prepared in the same manner as in Example 1 except that the amount of resin material A was changed to 1.1420 g, the amount of precursor A was changed to 0.2851 g and 0.029 g of photopolymerization initiator a was changed to 0.045 g of oligo[2-hydroxy-2-methyl-1-(4-(1-methylvinyl)phenyl)propanone] (weight average molecular weight: 1500; hereinafter referred to as photopolymerization initiator b) in Example 1.

As shown in Table 1, the sample of Example 5 shows large negative abnormal dispersibility satisfying the requirement (a), has high transparency with a transmittance of more than 85%, and has high heat resistance and a high refractive index of more than 1.52. Therefore, the hybrid lens of Example 5 has high transparency, large negative abnormal dispersibility, high heat resistance and a high refractive index.

The sample and the hybrid lens of Example 5 are obtained using high-molecular-weight photopolymerization initiator b, and therefore show larger negative abnormal dispersibility and a higher refractive index as compared to the sample and the hybrid lens of Example 2.

### Comparative Example 1

A sample and a hybrid lens of Comparative Example 1 were prepared in the same manner as in Example 1 except that the amount of resin material A was changed to 1.0000 g, the amount of photopolymerization initiator a was changed to 0.031 g, and precursor A was not used in Example 1.

Comparison between the sample of Comparative Example 1 and the samples of Examples 1 and 2 shows that the samples of Examples 1 and 2 have negative abnormal dispersibility much larger than that of the sample of Comparative Example 1, and has a refractive index higher than that of the sample of Comparative Example 1 while maintaining a high transmittance almost comparable to that of the sample of Comparative Example 1 as shown in Table 1. Therefore, it has become apparent that unlike the hybrid lens of Comparative Example 1, the hybrid lenses of Examples 1 and 2 obtained using the aliphatic polyimide precursor has high transparency, large negative abnormal dispersibility, high heat resistance and a high refractive index.

### Comparative Example 2

A sample and a hybrid lens of Comparative Example 2 were prepared in the same manner as in Example 3 except that the amount of resin material B was changed to 1.0000 g, the amount of photopolymerization initiator a was changed to 0.0305 g, and precursor B was not used in Example 3.

Comparison between the sample of Comparative Example 2 and the samples of Examples 3 and 4 shows that the samples of Examples 3 and 4 have negative abnormal dispersibility extremely larger than that of the sample of Comparative Example 2, and has a refractive index higher than that of the sample of Comparative Example 2 while maintaining a high transmittance almost comparable to that of the sample of Comparative Example 2 as shown in Table 1. Therefore, it has become apparent that unlike the hybrid lens of Comparative Example 2, the hybrid lenses of Examples 3 and 4 obtained using the aliphatic polyimide precursor has high transparency, large negative abnormal dispersibility, high heat resistance and a high refractive index.

### Comparative Example 3

A sample and a hybrid lens of Comparative Example 3 were prepared in the same manner as in Example 3 except that the amount of resin material B was changed to 1.0300 g, 0.0230 g of precursor B was changed to 0.0104 g of an aromatic polyimide (weight average molecular weight: 414; hereinafter referred to as polyimide C) obtained by subjecting a benzene-1,2,4,5-tetracarboxylic acid dianhydride and 4,4′-diaminodiphenyl ether to a polymerization reaction, the amount of photopolymerization initiator a was changed to 0.032 g, and the mixing temperature was changed to 250° C. in Example 3.

Comparison between the sample of Comparative Example 3 and the samples of Examples 3 and 4 shows that the sample of Comparative Example 3 has a refractive index almost comparable to the refractive indexes of the samples of Examples 3 and 4, but shows positive abnormal dispersibility, and has a transmittance extremely lower as compared to the samples of Examples 3 and 4 as shown in Table 1. Therefore, it has become apparent that the hybrid lens of Comparative Example 3 obtained using the conventional aromatic polyimide does not have high transparency, large negative abnormal dispersibility, high heat resistance and a high refractive index.

TABLE 1

| | Composition of optical resin composition | | | | | | |
|---|---|---|---|---|---|---|---|
| | Resin | | Photopolymerization | Mixing | Optical properties of resin lens | | |
| | material | Precursor | initiator | temperature | | | Transmittance |
| | (g) | (g) ^{note 1)} | (g) | (° C.) | nd | ΔPgF | (% T) |
| Example 1 | A(0.9207) | A(0.0466) | a(0.029) | 150 | 1.51797 | −0.0239 | 89.7 |
| 2 | A(1.1419) | A(0.2854) | a(0.044) | 150 | 1.52795 | −0.0350 | 86.4 |
| 3 | B(1.1100) | B(0.0230) | a(0.035) | 80 | 1.51950 | −0.0300 | 89.6 |
| 4 | B(0.9208) | B(0.0462) | a(0.020) | 80 | 1.52060 | −0.0600 | 87.9 |
| 5 | A(1.1420) | A(0.2851) | b(0.045) | 150 | 1.52810 | −0.0362 | 85.2 |
| Comparative | A(1.0000) | — | a(0.031) | — | 1.51568 | −0.0170 | 89.6 |
| Example 1 | | | | | | | |
| 2 | B(1.0000) | — | a(0.0305) | — | 1.51762 | −0.0028 | 89.8 |
| 3 | B(1.0300) | C(0.0104) | a(0.032) | 250 | 1.51903 | 0.0030 | 75.0 |

^{Note 1)}
The precursor in Comparative Example 3 is polyimide C.

The exemplary embodiment has been described above as an example of the technique in the present disclosure. Thus, the attached drawings and detailed descriptions have been provided.

Therefore, components described in the attached drawings and detailed descriptions may include not only components essential for solving the problems, but also components that are intended to merely illustrate the above-described techniques, and are not essential for solving the problems. Thus, the components that are not essential should not be considered to be essential simply because the components that are not essential are described in the attached drawings and detailed descriptions.

Since the exemplary embodiment described above is intended to illustrate the techniques in the present disclosure, change, replacement, addition, omission and so on can be made in a variety of ways in claims and equivalents thereof.

The present disclosure can be suitably used as an optical device such as a lens or a prism.

What is claimed is:

1. A composite optical device comprising
a glass lens; and a resin lens stacked on the glass lens, wherein
the resin lens is formed of an optical material; and
the optical material comprises an optical resin composition which contains
at least
a (meth)acrylate-based polymerizable compound; and
an aliphatic polyimide precursor obtained from a carboxylic acid anhydride having, in a molecular structure, a structure represented by general formula (α): -A¹-CO—O—CO-A²- wherein A¹ and A² are, each independently, a linear, branched or cyclic aliphatic group; and A¹ and A² may form the same cyclic aliphatic group,
the aliphatic polyimide precursor being dispersed in a resin material including the (meth)acrylate-based polymerizable compound.

2. The composite optical device according to claim 1, wherein the resin lens satisfies the following requirement (a):
ΔPgF<−0.02 (a)
wherein
ΔPgF is abnormal dispersibility.

3. The composite optical device according to claim 1, wherein the aliphatic polyimide precursor is dissolved at a temperature of 200° C. or lower, and dispersed in the resin material.

4. The composite optical device according to claim 1, wherein the (meth)acrylate-based polymerizable compound is a compound having sulfur atoms in a molecular structure.

5. The composite optical device according to claim 1, wherein
the polymerization initiator is a hydroxyketone compound having a weight average molecular weight of 1000 to 2000.

6. An optical material for a composite optical device, which comprises an optical resin composition which contains at least
a (meth)acrylate-based polymerizable compound; and
an aliphatic polyimide precursor obtained from a carboxylic acid anhydride having, in a molecular structure, a structure represented by general formula (α): -A¹-CO—O—CO-A²- wherein A¹ and A² are, each independently, a linear, branched or cyclic aliphatic group; and A¹ and A² may form the same cyclic aliphatic group,
the aliphatic polyimide precursor being dispersed in a resin material including the (meth)acrylate-based polymerizable compound.
